(19) United States
(12) Patent Application Publication
(10) Pub. No.: US 2025/0057252 A1
(43) Pub. Date: Feb. 20, 2025

(54) METHOD OF MANUFACTURING OR ASSEMBLING AN AEROSOL GENERATOR

(71) Applicant: Nicoventures Trading Limited, London (GB)

(72) Inventors: Zhihuang XIAO, London (GB); Daniel BALL, London (GB)

(21) Appl. No.: 18/723,446

(22) PCT Filed: Dec. 21, 2022
(86) PCT No.: PCT/EP2022/087369

§ 371 Date: Jun. 23, 2024

(30) Foreign Application Priority Data
Dec. 24, 2021 (GB) 2119029.3

(51) Int. Cl. A24F 40/70; A24F 40/465; H05B 6/10

(52) U.S. Cl. CPC A24F 40/70; A24F 40/465; H05B 6/108

(57) ABSTRACT

A method of manufacturing or assembling an aerosol generator for an aerosol provision device includes providing a tubular housing including a plurality of discrete ring electrodes embedded within a matrix, inserting a susceptor element, a plug element and a cleanout tube within the tubular housing, and securing the plug element to the tubular housing and contacting the susceptor element 3 with the plug element, and securing the cleanout tube to the tubular housing and contacting the susceptor element with the cleanout tube, in order to secure the susceptor element within the tubular housing.

### RELATED APPLICATIONS

The present application is a National Phase entry of PCT Application No. PCT/EP2022/087369 filed Dec. 21, 2022, which claims priority to GB Application No. 2119029.3 filed Dec. 24, 2021, each of which is hereby incorporated by reference in their entirety.

### TECHNICAL FIELD

The present invention relates to a method of manufacturing or assembling an aerosol generator, a method of manufacturing or assembling an aerosol provision device, an aerosol generator, an aerosol provision device and an aerosol generating system, a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Known magnetic field generating devices include inductive coils. An inductive coil may be formed with a suitable geometry for achieving the desired heating of the material. This can be achieved by winding a suitable material, such as a LITZ (RTM) wire, into the desired coil shape. However, the shape (e.g. pitch) of the coil may be unintentionally altered as the device is assembled, which can prevent the desired heating of the material from being achieved.

It is desired to provide an improved aerosol provision device.

### SUMMARY

According to an aspect there is provided a method of manufacturing or assembling an aerosol generator for an aerosol provision device, the method comprising:
providing a tubular housing comprising a plurality of discrete ring electrodes embedded within a matrix;
inserting a susceptor element, a plug element and a cleanout tube within the tubular housing;
securing the plug element to the tubular housing and contacting the susceptor element with the plug element and securing the cleanout tube to the tubular housing and contacting the susceptor element with the cleanout tube in order to secure the susceptor element within the tubular housing.

According to various embodiments a method of assembling an aerosol generator is disclosed wherein the various components can be easily assembled without requiring the use of fixings, glue or specialist tools. For example, a tubular housing comprising a plurality of ring electrodes embedded within a matrix and formed by an injection molding process may be provided. A susceptor element may be secured to the tubular housing between a plug element and a cleanout tube. According to an embodiment the susceptor element may be held under compression between the plug element and the cleanout tube. Both the plug element and the cleanout tube may be attached to the tubular housing and the susceptor element without the use of fixings, glue or specialist tools i.e. the components may snap-fit or make a compression fit with each other.

Optionally, the plurality of discrete ring electrodes embedded within the matrix comprise an inductor.

Optionally, the susceptor element may be secured within the tubular housing by virtue of being positioned or held under compression between the plug element and the cleanout tube.

Optionally, the step of securing the plug element to the tubular housing comprises inserting the plug element into the tubular housing and making a snap fit or interference fit with the tubular housing and/or the susceptor element.

Optionally, the step of securing the cleanout tube to the tubular housing comprises inserting the cleanout tube into the tubular housing and making a snap fit or interference fit with the tubular housing and/or the susceptor element.

Optionally, the step of providing the tubular housing comprises injection molding the matrix around the ring electrodes.

Optionally, the step of injection molding comprises:
positioning a plurality of ring electrodes within a mold;
injecting a matrix into the mold; and
causing the matrix to harden around the plurality of ring electrodes to form the tubular housing.

Optionally, the matrix or tubular housing comprises a thermoplastic material.

Optionally, the matrix or tubular housing comprises polyetheretherketone (“PEEK”).

Optionally, the method further comprises arranging for portions of the ring electrodes to extend beyond the tubular housing so as to form electrical connections.

Optionally, the method further comprises mounting, securing or soldering the electrical connections to a first substrate.

Optionally, the first substrate comprises a first printed circuit board (“PCB”).

Optionally, the first substrate comprises one or more electrical connectors or pads and the method further comprises:
electrically connecting the one or more electrical connectors or pads to one or more electrical connectors or pads provided on a second substrate.

Optionally, the second substrate comprises a second printed circuit board (“PCB”).

Optionally, the plurality of discrete ring electrodes comprises 2, 3, 4, 5, 6, 7, 8, 9, 10, 11, 12, 13, 14, 15, 16, 17, 18, 19, 20 or more than 20 ring electrodes.

Optionally, the plurality of ring electrodes are arranged co-axially within the tubular housing.

Optionally, the plurality of ring electrodes are spaced equally axially.

Optionally, the plurality of ring electrodes are grouped into at least a first group of ring electrodes and a second group of ring electrodes.

Optionally, the method further comprises securing one or more thermocouple wires to the susceptor element.

Optionally, the method further comprises passing the one or more thermocouple wires through an aperture or cut-out provided in the tubular housing.

Optionally, the method further comprises inserting a seal into the aperture or cut-out provided in the tubular housing in order to form a seal around the one or more thermocouple wires with the tubular housing.

Optionally, the method further comprises passing the one or more thermocouple wires through an aperture or cut-out provided in a first substrate.

Optionally, the method further comprises applying a ferrite shield layer to the tubular housing.

Optionally, the step of applying a ferrite shield layer to the tubular housing comprises using a self-adhesive to adhere the ferrite shield to the tubular housing.

According to another aspect there is provided a method of manufacturing or assembling an aerosol generator for an aerosol provision device, the method comprising:
providing a tubular housing comprising a plurality of discrete ring electrodes embedded within a matrix, the tubular housing comprising an integral plug element;
inserting a susceptor element into the tubular housing so as to contact the integral plug element;
inserting a cleanout tube into the tubular housing; and
securing the cleanout tube to the tubular housing and contacting the susceptor element with the cleanout tube in order to secure the susceptor element within the tubular housing.

According to another aspect there is provided a method of manufacturing or assembling an aerosol generator for an aerosol provision device, the method comprising:
providing a tubular housing comprising a plurality of discrete ring electrodes embedded within a matrix, the tubular housing comprising an integral cleanout tube;
inserting a susceptor element into the tubular housing so as to contact the integral cleanout tube;
inserting a plug element into the housing; and
securing the plug element to the tubular housing and contacting the susceptor element with the plug element in order to secure the susceptor element within the tubular housing.

According to another aspect there is provided a method of manufacturing or assembling an aerosol provision device comprising a method as disclosed above.

According to another aspect there is provided an aerosol generator comprising:
a tubular housing comprising a plurality of discrete ring electrodes embedded in a matrix;
a plug element;
a cleanout tube; and
a susceptor element;
wherein the plug element is secured to the tubular housing and contacts the susceptor element and wherein the cleanout tube is secured to the tubular housing and contacts the susceptor element in order to secure the susceptor element within the tubular housing.

According to another aspect there is provided an aerosol generator comprising:
a tubular housing comprising a plurality of discrete ring electrodes embedded in a matrix, the tubular housing further comprising an integral plug element;
a cleanout tube; and
a susceptor element;
wherein the plug element contacts the susceptor element and wherein the cleanout tube is secured to the tubular housing and contacts the susceptor element in order to secure the susceptor element within the tubular housing.

According to another aspect there is provided an aerosol generator comprising:
a tubular housing comprising a plurality of discrete ring electrodes embedded in a matrix, the tubular housing further comprising an integral cleanout tube;
a plug element; and
a susceptor element;
wherein the plug element is secured to the tubular housing and contacts the susceptor element and wherein the cleanout tube contacts the susceptor element in order to secure the susceptor element within the tubular housing.

Optionally, the susceptor element is secured to the tubular housing by virtue of by virtue of being positioned or held under compression between the plug element and the cleanout tube.

According to another aspect there is provided an aerosol provision device comprising:
an aerosol generator as described above.

According to another aspect there is provided an aerosol generating system comprising:
an aerosol provision device as described above; and
an aerosol generating article.

According to another aspect there is provided a method of generating an aerosol comprising:
providing an aerosol provision device as described above;
inserting an aerosol generating article into the aerosol provision device; and
energizing the ring electrodes to thereby heat the susceptor element and the aerosol generating article.

According to another aspect there is provided a method of manufacturing an aerosol generator comprising:
positioning a plurality of discrete ring electrodes in a mold;
injecting a matrix into the mold; and
allowing the matrix to cool or harden so as to form a tubular housing having a plurality of ring electrodes embedded therewithin.

### BRIEF DESCRIPTION OF THE DRAWINGS

Various embodiments will now be described, by way of example only, and with reference to the accompanying drawings in which:

FIG. 1 shows an aerosol provision device according to an embodiment, wherein the aerosol provision device comprises an inductor formed from a plurality of discrete ring electrodes mounted to a first substrate which comprises a printed circuit board;

FIG. 2 shows an inductor according to an embodiment comprising a plurality of ring electrodes mounted to a first substrate which comprises a printed circuit board;

FIG. 3 shows a cross sectional view of an aerosol generator according to an embodiment;

FIG. 4 shows a side view of the aerosol generator according to an embodiment;

FIG. 5 shows a side view of an aerosol generator according to an embodiment;

FIG. 6 shows a cross-sectional view of an aerosol generator according to an embodiment;

FIG. 7 shows a method of assembling an aerosol generator for an aerosol provision device in accordance with an embodiment of the present disclosure;

FIG. 8 shows a method of inserting a susceptor element into a tubular housing according to an embodiment;

FIG. 9A shows a method of inserting a seal into an aperture or cut-out provided in the tubular housing in order to form a seal around one or more thermocouple wires and FIG. 9B shows a method of attaching, mounting, securing or soldering the electrical connections of ring electrodes to a first substrate;

FIG. 10A shows an assembled aerosol generator according to an embodiment, FIG. 10B shows a different view of an assembled aerosol generator according to an embodiment and FIG. 10C shows an end-on view of an assembled aerosol generator;

FIG. 11 shows the step of applying a ferrite shield layer to the tubular housing according to an embodiment;

FIG. 12 shows how a plug element may be inserted in a tubular housing according to an embodiment after a ferrite shield has been applied to the tubular housing; and

FIG. 13A shows a view of an aerosol generator once assembled and FIG. 13B shows another view of an aerosol generator once assembled.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

In some embodiments, the aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

Various embodiments will now be described in more detail.

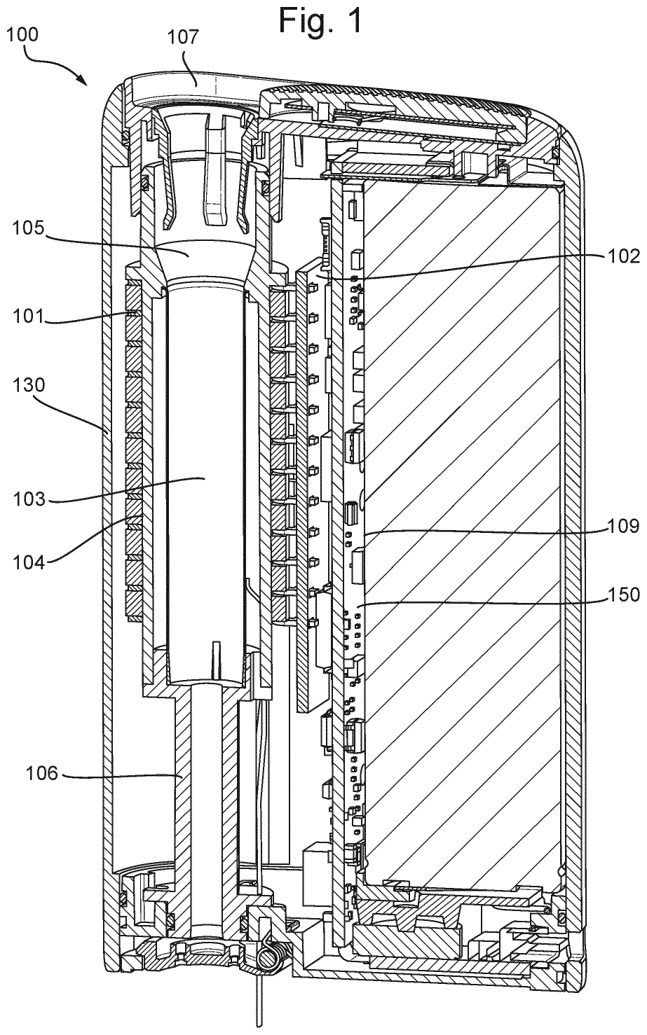

FIG. 1 shows an aerosol provision device 100 according to an embodiment. The aerosol provision device 100 comprises an outer housing 130 and an inductor or inductive heating element comprising a plurality of ring electrodes 101 arranged around a tubular heating chamber housing 104.

As will be described in more detail below the plurality of ring electrodes 101 may be embedded in a matrix to form the tubular heating chamber housing 104. In particular, the tubular heating chamber housing 104 may be formed by an injection molding process which will be described in more detail below.

A susceptor 103 is provided within the heating chamber housing 104 and a heating chamber is formed within the susceptor 103. A lid or slidable cover 107 is provided at the entrance to the heating chamber. An aerosol generating article may be inserted via the lid or slidable cover 107 into the heating chamber and may be surrounded by at least a portion of the susceptor 103.

It will be understood that the susceptor 103 will become hot due to interacting with an magnetic field emitted by the inductor or inductive heating element comprising a plurality of ring electrodes 101. As a result, an aerosol generating article located within the susceptor 103 will become heated.

The inductor or inductive heating element comprises a plurality of ring electrodes 101 mounted to a first substrate 102. The first substrate 102 may comprise a printed circuit board (“PCB”). According to various embodiments the inductor or inductive heating element may comprise 2, 3, 4, 5, 6, 7, 8, 9, 10, 11, 12, 13, 14, 15, 16, 17, 18, 19, 20 or more than 20 ring electrodes 101.

The susceptor 103 is located within the heating chamber housing 104 and may be mounted or held under compression between an upper portion 105 of the heater chamber housing 104 and a cleanout tube 106. It should be understood that reference to being held in compression relates to the location of the susceptor 103 rather than the susceptor 103 being subjected to a high compressive force.

The upper portion 105 of the heater chamber housing 104 may comprise a discrete component which may be referred to as a plug element. Alternatively, the upper portion 105 of the heater chamber housing 104 may be integral with the main body of the heating chamber housing 104. According to this embodiment a plug element may be integral with the main body of the heating chamber housing 104 and the susceptor 103 and cleanout tube 106 may be inserted via a lower opening in the heating chamber housing 104.

Various different ways of assembling or manufacturing the disclosed arrangement are contemplated. According to an embodiment the susceptor 103 may be inserted into the heating chamber housing 104 via a lower opening and attached to (or brought into contact with) the upper portion 105 of the heater chamber housing 104. A cleanout tube 106 may then be inserted and secured to both the heater chamber housing 104 and the susceptor 103. Embodiments are contemplated wherein the susceptor 103 is held under compression between the upper portion 105 of the heater chamber housing 104 and the cleanout tube 106.

Embodiments are also contemplated wherein the cleanout tube 106 may be integral with the heater chamber housing 104. According to this embodiment, the susceptor 103 and a plug element may be inserted into the heating chamber housing 104 via an upper opening in the heating chamber housing 104.

According to an embodiment a method of manufacturing or assembling an aerosol generator for an aerosol provision device is disclosed wherein the method comprises: providing a tubular housing 104 comprising a plurality of discrete ring electrodes 101 embedded within a matrix, the tubular housing 104 comprising an integral plug element. The method may comprise inserting a susceptor element 103 into the tubular housing 104, contacting the susceptor element 103 to the integral plug element, inserting a cleanout tube 106 into the tubular housing 104 and securing the cleanout tube 106 to the tubular housing 104 and contacting the susceptor element 103 with the cleanout tube 106 in order to secure the susceptor element 103 within the tubular housing 104.

According to an alternative method a tubular housing 104 comprising a plurality of discrete ring electrodes 101 embedded within a matrix may be provided. The tubular housing 104 may comprise an integral cleanout tube 106. The method may further comprise inserting a susceptor element 103 into the tubular housing 104 and securing the susceptor element 103 to the integral cleanout tube 106 (or bringing the susceptor element 103 into contact with the integral cleanout tube 106). The method may further comprise inserting a plug element into the housing 104 and securing the plug element to the tubular housing 104 and contacting the susceptor element 103 in order to secure the susceptor element 103 within the tubular housing 104.

The susceptor 103 comprises a heating material that is heatable by penetration with a varying magnetic field, such as an alternating magnetic field. The susceptor 103 may comprise an electrically conductive material, so that penetration thereof with a varying magnetic field causes induction heating of the heating material. The heating material may be magnetic material, so that penetration thereof with a varying magnetic field causes magnetic hysteresis heating of the heating material. The susceptor 103 may be both electrically conductive and magnetic, so that the susceptor 103 is heatable by both heating mechanisms. The susceptor 103 may comprise a ferroelectric and/or ferromagnetic material.

An aerosol generating article may be inserted through the entrance to the heating chamber which is formed by the susceptor 103. The aerosol generating article may be received within the heating chamber such that the aerosol generating article is in thermal communication with the susceptor 103. Accordingly, when the susceptor 103 is inductively heated, the susceptor 103 may conduct heat to the aerosol generating article and thereby causing an aerosol to be generated from aerosol generating material which comprises the aerosol generating article.

A control device 109 may be provided on a second substrate 150 (which may also comprise a printed circuit board) and may be connected to the first substrate 109 via one or more electrical connections. The control device 109 may be arranged to apply an AC or RF voltage to the ring electrodes 101 in order to generate a time varying magnetic field. The time varying magnetic field will cause the heating material of the susceptor 103 to be heated.

According to an embodiment the control device 109 may be configured to independently apply an AC or RF voltage to individual ring electrodes 101. Alternatively, the control device 109 may be arranged to apply an AC or RF voltage to groups of ring electrodes 101.

It will be understood that passing an alternating current through each of the ring electrodes 101 will generate an alternating magnetic field which will cause a corresponding region of the susceptor 103 to be heated.

As shown in FIG. 1, the control device 109 may be provided on a second substrate 150 which is separate to the first substrate 102 to which the ring electrodes 101 are mounted. However, other embodiments are contemplated wherein all or part of the components of the control device 109 may be located on the same first substrate 102 that the ring electrodes 101 are mounted to.

According to various embodiments the first substrate 102 and the second substrate 150 may comprise printed circuit boards (PCBs). The first substrate 102 or printed circuit board may comprise one or more connectors or pads on a rear surface of the first substrate 102 which may be arranged to connect electrically with corresponding connectors or pads provided on a front surface of the second substrate 150 or printed circuit board.

Embodiments are contemplated wherein the control device 109 may be located on a different substrate 150 to that of the first substrate 102 to which the ring electrodes 101 are mounted and wherein a wireless connection may be made between the first substrate 102 and the other substrate 150.

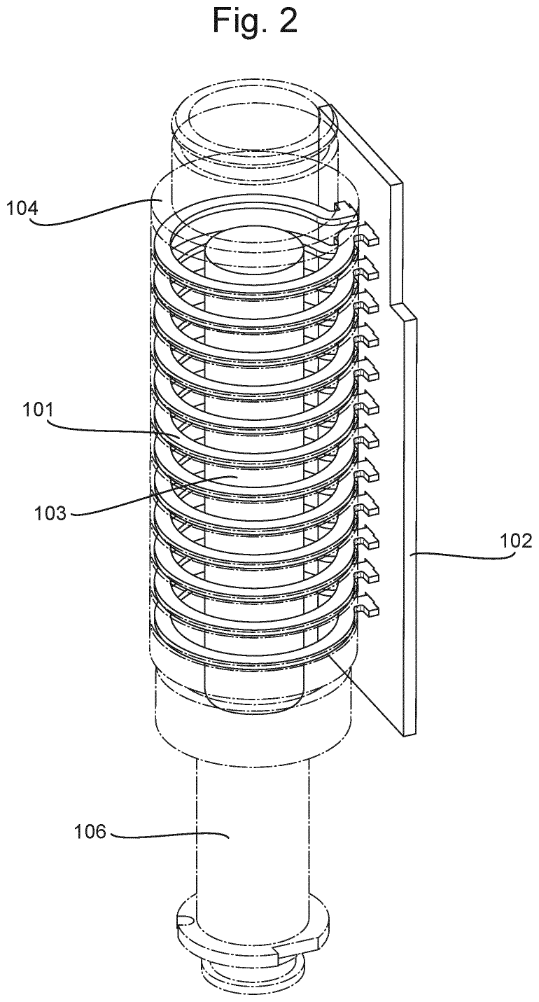

FIG. 2 shows in greater detail an inductor or inductive heating element according to an embodiment wherein the inductor or inductive heating element comprises a plurality of discrete ring electrodes 101 mounted to a first substrate 102. According to the particular embodiment shown in FIG. 2 twelve ring electrodes 101 are mounted to the first substrate 102. However, it will be appreciated that according to other embodiments a different number of ring electrodes 101 may be mounted to the first substrate 102.

The inductor or inductive heating element according to various embodiments comprising a plurality of discrete ring electrodes 101 can allow for different desired inductor geometries to be easily constructed. For example, the number of ring electrodes 101 can be varied and/or the separation distance between the ring electrodes 101 can be varied. This enables different heating profiles to be achieved.

According to various embodiments the ring electrodes 101 may be embedded within a matrix.

According to various embodiments the ring electrodes 101 may comprise rigid electrodes embedded within a matrix with the result that when the ring electrodes 101 are provided on or secured to the first substrate 102 then a robust inductor or inductive heating element may be provided. It will be appreciated, therefore, that according to various embodiments an aerosol provision device may be provided which is particularly rugged and robust.

Each of the discrete ring electrodes 101 may be provided as a discontiguous element which is mounted to the first substrate 102 and wherein each ring electrode 101 is separate from one another.

Each ring electrode 101 may comprise a ring section or portion with an electrical connection portion at each end. The ends of the ring electrodes 101 may comprise electrical connection portions and the electrical connection portions may be attached or otherwise secured to the first substrate 102. Each ring electrode 101 may be electrically connected to, and supported by, the first substrate 102 via the electrical connection portions.

According to various embodiments each ring electrode 101 may comprise two electrical connection portions which allows the ring electrodes 101 to be positioned on the first substrate 102 independently of the other ring electrodes 101 whilst allowing for a suitable electrical connection with the first substrate 102. Each ring electrode 101 may have its own electrical connection to the first substrate 102 independent of the electrical connections of at least some of the other electrodes 101 to the first substrate 102 so as to allow for independent control of particular electrodes(s) 102.

The ring electrodes 101 may be mounted to the first substrate 102 in any suitable manner. In an embodiment, the electrical connection portions and/or the first substrate 102 may be configured and adapted for connection to one another. For example, the electrical connection portions of the ring electrodes 101 and the first substrate 102 may be configured for the electrical connection portions to be inserted into corresponding holes or slots provided in the first substrate 102. Other embodiments are contemplated wherein the electrical connection portions comprise holes or slots configured for attachment to corresponding electrodes provided on the first substrate 102. Attachment means, such as screws, may be used.

According to an embodiment the ring electrodes 101 may be soldered to the first substrate 102. In order to facilitate this, the electrical connection portions may be configured to be soldered into corresponding slots provided in the first substrate 102 which may comprise a printed circuit board. The electrical connection portions may be coated with a material (e.g. gold) to facilitate solder connection to the first substrate 102.

According to various embodiments, insertion of the electrical connection portions into corresponding slots on the first substrate 102 may be sufficient to secure the ring electrodes 101 to the first substrate 102 and to form an electrical connection between the first substrate 102 and the ring electrodes 101. For example, according to various embodiments the ring electrodes 101 may be connected to the first substrate 102 by virtue of an interference fit or snap fit.

According to various embodiment a method of manufacturing or assembling an aerosol generator is disclosed which comprises the step of arranging for portions of the ring electrodes 101 to extend beyond the tubular housing 104 so as to form electrical connections. The method may further comprising mounting, securing or soldering the electrical connections to a first substrate 102, wherein the first substrate comprises a first printed circuit board (“PCB”). The first substrate 102 may comprise one or more electrical connectors or pads and the method may further comprise electrically connecting the one or more electrical connectors or pads to one or more electrical connectors or pads provided on a second substrate 150. The second substrate 150 may comprise a second printed circuit board (“PCB”).

An alternating current may be arranged to pass through the ring portions of the electrodes 101 via the electrical connection portions thereby generating a varying magnetic field. It will be understood that the varying magnetic field will cause the susceptor 103 located radially inwards of the ring electrodes 101 to become heated. The susceptor 103 may be located within a volume defined by the internal radius of the ring portions of the ring electrodes 101. One end of the susceptor 103 may be secured to a portion of a heater chamber housing 104. Another end of the susceptor 103 may be secured to a cleanout tube 106.

The ring electrodes 101 may be arranged so as to be co-axial with one another. Each of the ring electrodes 101, or at least the ring portions thereof, may be substantially flat i.e. planar. The ring electrodes 101 may be substantially flat in a plane which is perpendicular to an axial direction of the ring electrodes 101 or a longitudinal axis of the inductor or inductive heating element. The ring electrodes 101 may be aligned with one another when attached to the first substrate 102 such that planar surfaces of the ring electrodes 101 are in parallel planes to one another. Providing planar ring electrodes 101 can allow for localised heating of relatively small portions of the susceptor 103 by each ring electrode 101 thereby enabling accurate control of the temperature distribution along the length of the susceptor 103.

Other embodiments are contemplated wherein the ring electrodes 101 may be non-planar e.g. helical so that relatively fewer electrodes may allow the heating of relatively greater lengths of a susceptor 103. The ring electrodes 101 may have a rectangular, circular or polygonal cross-sectional profile. The ring portions may comprise an electrically-conductive material e.g. copper or gold. It is also contemplated that a conductive track may be provided on one or both planar surfaces of each ring electrode 101 or the ring portion itself may consist (entirely) of electrically-conductive material (e.g. copper). The ring electrodes 101 may be constructed by, for example, being cut from a planar sheet of material, or by an elongate piece of material being bent into the required shape. The ring electrodes 101 are shown mounted to a heater chamber housing 104 which is connected to a cleanout tube 106.

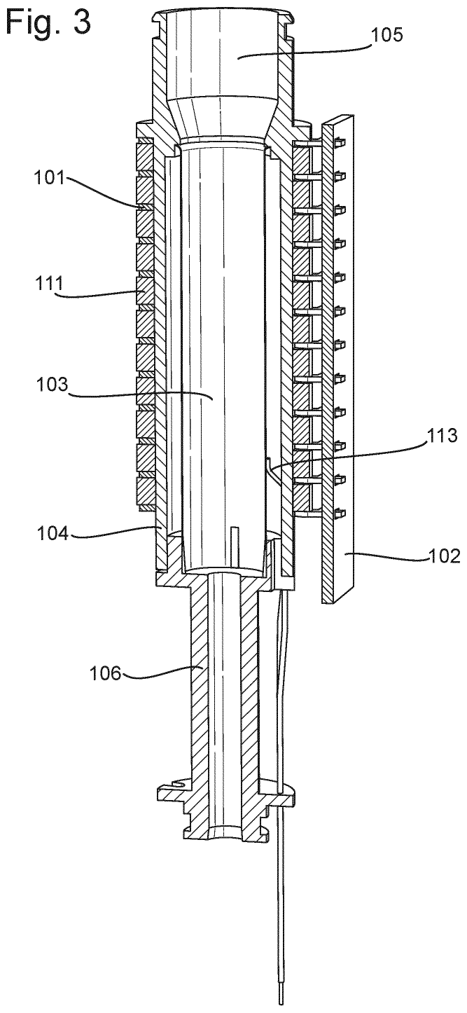

FIG. 3 shows a cross sectional view of an aerosol generator according to various embodiments. The aerosol generator comprises an inductor or inductive heating element comprising a plurality of discrete ring electrodes 101 mounted to a first substrate 102 which may comprise a printed circuit board. The ring electrodes 101 are embedded within a heater chamber housing 104. The aerosol generator further comprises a susceptor 103 located within the heater chamber housing 104.

According to an embodiment the susceptor 103 may be mounted between an upper portion 105 of the heater chamber housing 104 and a cleanout tube 106. The heater chamber housing 104 may be located within the ring portions of the ring electrodes 101 and the susceptor 103 may be located within the heater chamber housing 104.

The electrical connection portions of the ring electrodes 101 may extend beyond the heater chamber housing 104 to allow for connection to the first substrate 102. A plurality of spacers 111 formed of electrically insulating material (e.g. a thermoplastic, such as polyetheretherketone (PEEK)) may be located between the ring electrodes 101. The spacers 111 may have a cross-sectional shape substantially corresponding to the ring portions of the electrodes 101.

However, it should be understood that the spacers 111 are optional and the ring electrodes 101 and/or heater chamber housing 104 may have sufficient rigidity such as not to require any spacers 111 being provided between the ring electrodes 101. For instance, the heater chamber housing 104 may be formed with spacer portions between each of the ring electrodes instead of the spacers 111.

According to various embodiments the ring electrodes 101 may be embedded within a matrix so as to form a tubular housing 104 which forms the heater chamber housing 104. The ring electrodes 101 may be embedded within the matrix during an injection molding process and it will be understood that the tubular housing 104 including the embedded ring electrodes 101 may be particular robust. Accordingly, no spacers 111 may be utilized.

According to various embodiments a temperature sensor 113, such as a thermocouple, may be attached to the susceptor 103 for sensing a temperature of the susceptor 103.

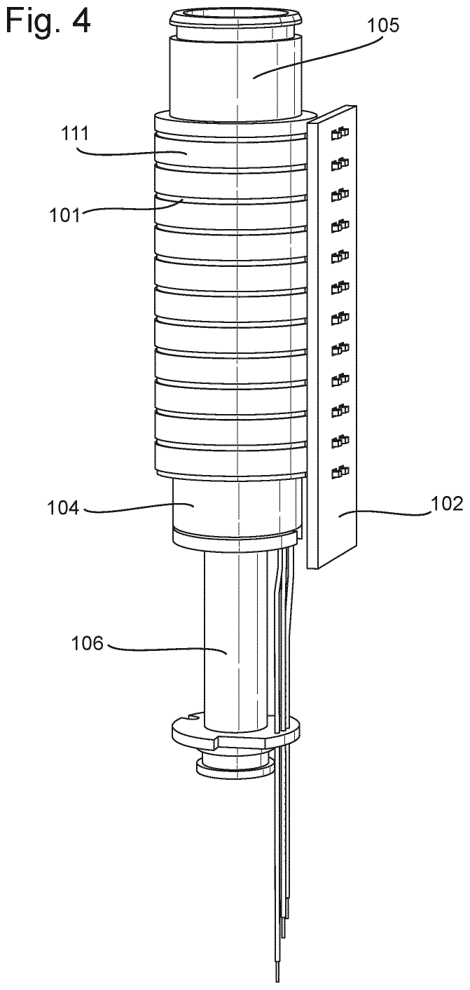

FIG. 4 shows a side view of the ring electrodes 101, spacers 111, the heater chamber housing 104, an upper portion of the heater chamber housing 105, a cleanout tube 106 and a first substrate 102 mounted to electrical connection portions of the ring electrodes 101.

According to various embodiments the ring electrodes 101 may be embedded within the heater chamber housing 104.

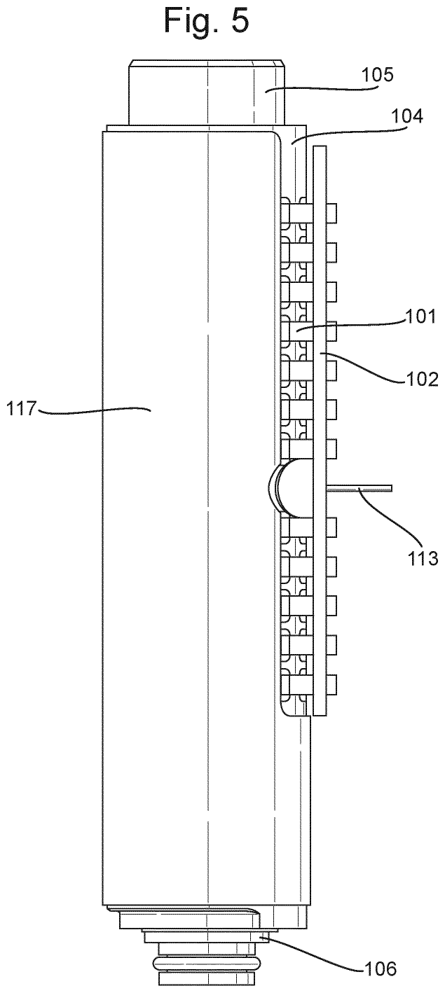

FIG. 5 shows a side view of an aerosol generator according to various embodiments. The aerosol generator comprises an inductor or inductive heating element comprising a plurality of discrete ring electrodes 101 mounted to a first substrate 102 (e.g. a PCB). The aerosol generator further comprises a susceptor (not shown), a heater chamber housing 104, an upper housing 105 and a cleanout tube 106.

The ring electrodes 101 may be embedded in a matrix to form the heater chamber housing 104. According to an embodiment the matrix may be injection molded around the ring electrodes 101 in order to form the heater chamber housing 104. The matrix or heater chamber housing 104 may comprise a thermo-plastic material such as polyetheretherketone (PEEK).

The first substrate 102 (e.g. PCB) may be connected to the ring electrodes 101 before or after the heater chamber housing 104 has been formed around the ring electrodes 101. One end of the heater chamber housing 104 may be configured for attachment to the upper housing 105 and the other end of the heater chamber housing 104 may be configured for attachment to a cleanout tube 106. A susceptor element may be located within the heating chamber housing 104 between the cleanout tube 106 and the upper housing 105. According to various embodiments the susceptor may be held under compression between the upper housing 105 and the cleanout tube 106.

A shielding material 117 may be provided around an exterior of the ring electrodes 101 in order to prevent the magnetic field generated by the ring electrodes 101 being transmitted radially outwards and hence in the direction of the user. A thermocouple 113 may be attached to the susceptor in order to measure the temperature of the susceptor element.

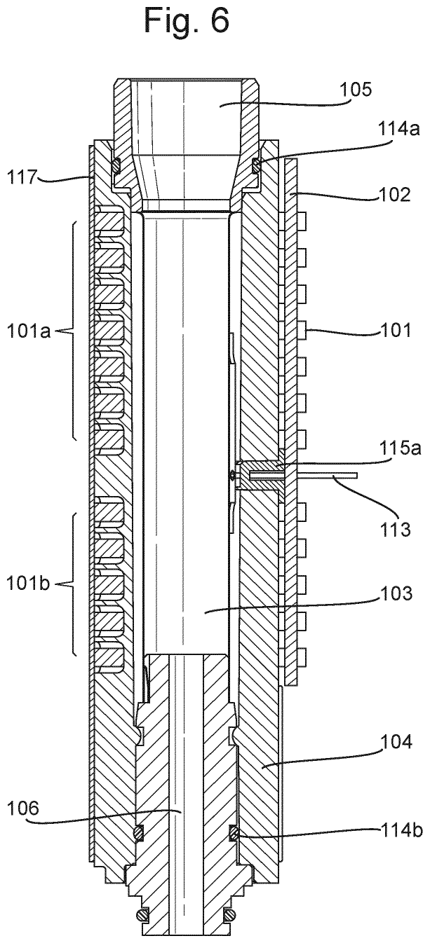

FIG. 6 shows a cross-sectional view of an aerosol generator according to an embodiment. According to an embodiment a first seal 114a may be provided between an upper housing 105 and the heater chamber housing 104. A second seal 114b may be provided between the heater chamber housing 104 and the cleanout tube 106.

The heater chamber housing 104 may be formed with an integral or contiguous upper portion in place of a separate discrete upper housing 105. The upper housing 105 may comprise a thermoplastic material such as polyetheretherketone (PEEK). The heater chamber housing 104 may be formed with a hole or slot into which a thermocouple 113 may be inserted. The thermocouple 113 may be arranged to sense the temperature of the susceptor 103. A seal 115a may be provided to secure the thermocouple 113 within the hole or slot provided in the heater chamber housing 104. The seal 115a may abut a surface of a first substrate 102 which a plurality of ring electrodes 101 are attached thereto.

A shielding material 117 may be provided around an exterior of the ring electrodes 101 in order to attenuate the magnetic field generated by the ring electrodes 101 in a radial direction towards the outer housing of the aerosol provision device. According to various embodiments the shielding material 117 may be provided as an adhesive wrap. The shielding material 117 may comprise a magnetic material such as a ferrite.

The susceptor 103 may be secured within the heater chamber housing 104 by being attached to (or contacting) a cleanout tube 106 at one end and by being attached to (or contacting) the upper housing 105 and/or an upper portion of the heater chamber housing 104 at another end. For instance, when the heater chamber housing 104 comprises an integral upper portion 105, the susceptor 103 may be inserted into the heater chamber housing 104 from the opposite end to the upper portion 105. Once the susceptor 103 has been inserted then the cleanout tube 106 may be configured for attachment to (or to contact) an end of the susceptor 103. According to an embodiment the cleanout tube 106 may make a snap fit connection with the susceptor 103 in order to secure the susceptor 103 between the upper portion 105 and the cleanout tube 106. Other embodiments are contemplated wherein the susceptor 103 is held under compression between the upper portion 105 and the cleanout tube 106.

According to an embodiment the cleanout tube 106 may be configured for attachment to the susceptor 103 so that the cleanout tube 106 is first attached to the susceptor 103 before both the susceptor 103 and attached cleanout tube 106 are then inserted together into the heater chamber housing 104 and secured to an upper portion of the heater chamber housing 104.

When a discrete upper housing 105 is provided, the susceptor 103 may be inserted into the heater chamber housing 104 via a bottom portion of the heater chamber housing 104 in a manner as discussed above. Alternatively, the susceptor 103 may be inserted through the top end of the heater chamber housing 104 and then the upper housing 105 may then be secured to (or brought into contact with) the susceptor 103. The upper housing 105 may be configured for attachment to the heater chamber housing 104 using, for example, a compression fit.

According to various embodiments the plurality of ring electrodes 101 may be arranged in one or more groups of electrodes. For example, the aerosol generator may be configured to heat different regions of a susceptor 103 (and hence different regions of an aerosol generating article) to different temperatures. For example, each group of electrodes 101 may be arranged to maintain a corresponding portion of the susceptor 103 at a different temperature during a session of use.

According to an embodiment as shown in FIG. 6, the ring electrodes 101 may be arranged into a first group 101a of ring electrodes and a second group 101b of ring electrodes. In the specific embodiment shown in FIG. 6 the first group 101a of ring electrodes comprises seven ring electrodes 101 and the second group 101b of ring electrodes comprises five ring electrodes 101. However, it will be understood that both the first group of ring electrodes 101a and the second group 101b of ring electrodes may comprise a different number of ring electrodes 101.

It is contemplated that different regions of the susceptor 103 may be maintained at different temperatures during use. This may be achieved by applying different voltages to the first group 101a of ring electrodes to that of the second group 101b of ring electrodes.

Other embodiments are contemplated wherein the axial separation (pitch) between the electrodes 101 in the different groups and/or the number of electrodes 101 in the different groups of electrodes may vary. For example, the first group 101a of ring electrodes may have a first axial spacing S1 between electrodes and the second group 101b of ring electrodes may have a second different axial spacing S2 between electrodes. According to an embodiment the first axial spacing S1 may be <1 mm, 1-2 mm, 2-3 mm, 3-4 mm, 4-5 mm, 5-6 mm, 6-7 mm, 7-8 mm, 8-9 mm, 9-10 mm or >10 mm. Similarly, according to an embodiment the second axial spacing S2 may be <1 mm, 1-2 mm, 2-3 mm, 3-4 mm, 4-5 mm, 5-6 mm, 6-7 mm, 7-8 mm, 8-9 mm, 9-10 mm or >10 mm.

It is contemplated that different temperatures may additionally or otherwise be provided by the aerosol provision device being configured to supply different groups of electrodes 101 with different voltages and/or currents. The aerosol provision device may comprise a control device 109 (as shown and described above in relation to FIG. 1) which may be configured to independently apply either one or more AC or RF voltages to groups of ring electrodes 101. This can allow a different voltage to be independently applied to different groups of ring electrodes 101.

For example, the control device 109 may be configured to apply different non-zero voltages to different groups of ring electrodes 101 at the same time and/or to apply a voltage to one or more groups of ring electrodes 101 while applying substantially no voltage to one or more other groups of ring electrodes 101. The control device 109 may be arranged to independently apply either one or more AC or RF voltages to individual ring electrodes 101 in the same group or in different groups.

According to an embodiment the control device 109 may be arranged to supply a first voltage V1 to the first group 101a of ring electrodes and a second voltage V2 to the second group 101b of ring electrodes. According to various embodiment the ratio V1/V2 may be in the range <0.5, 0.5-0.6, 0.6-0.7, 0.7-0.8, 0.8-0.9, 0.9-1.0, 1.0-1.1, 1.1-1.2, 1.2-1.3, 1.3-1.4, 1.4-1.5 or >1.5.

According to an embodiment the frequency f1 of the first voltage V1 and the frequency f2 of the second voltage V2 may be different. According to various embodiment the ratio f1/f2 may be in the range <0.5, 0.5-0.6, 0.6-0.7, 0.7-0.8, 0.8-0.9, 0.9-1.0, 1.0-1.1, 1.1-1.2, 1.2-1.3, 1.3-1.4, 1.4-1.5 or >1.5.

According to other embodiments the aerosol generator may comprise a single group of ring electrodes 101 and the control device 109 may be arranged to independently apply one or more AC or RF voltages to each of the individual ring electrodes 101.

Maintaining different regions of the susceptor 103 at different temperatures can allow for selectively heating of different portions of an aerosol generating article inserted into the aerosol generator, while not heating other particular portions of the aerosol generating article. For instance, the control device 109 may be configured to apply one or more voltages to a first group 101a of ring electrodes 101 in order to heat a first portion of the aerosol generating article at a first time t1, while not heating a second portion of the aerosol generating article at the same first time t1.

At a second time t2, the control device 109 may be configured to apply one or more voltages to a second group 101b of ring electrodes to heat a second portion of the aerosol generating article, while not heating the first portion of the aerosol generating article at the second time t2.

The control device 109 may additionally or alternatively be configured to apply a particular voltage to a particular group of electrodes to heat one portion of the aerosol generating article to one temperature, and at the same time, to apply a different voltage to a different group of electrodes in order to heat a different portion of the aerosol generating article to a different temperature.

The control device 109 may comprise or consist of a circuit or circuitry. The circuit/circuitry may be programmable and configured by software. According to various embodiments the control device 109 may be located on a first substrate 102 which a plurality of ring electrodes 101 are mounted to or alternatively the control device 109 may be located on a separate substrate e.g. on a separate printed circuit board which may be connected to the first substrate 102.

Each of the groups of ring electrodes 101 may be axially spaced apart from one another. The ring electrodes 101 may be arranged such that planar surfaces of the ring electrodes 101 in different groups are in parallel planes to one another. Each group of electrode(s) 101 may comprise 1, 2, 3, 4, 5, 6, 7, 8, 9, 10, 11, 12, 13, 14, 15, 16, 17, 18, 19, 20 or more than 20 ring electrodes 101.

Embodiments are contemplated wherein the ring electrodes 101 may be grouped into 1, 2, 3, 4, 5, 6, 7, 8, 9, 10 or more than 10 groups of electrodes 101. Each of the groups may comprise the same number or different numbers of ring electrodes 101. Each group of ring electrodes 101 may comprise at least 2, 3, 4, 5, or more than 5 ring electrodes 101. For instance, according to an embodiment the ring electrodes 101 may be arranged into between 2 to 5 groups of ring electrodes 101, wherein each group of ring electrodes 101 comprises at least three ring electrodes 101. The different groups of ring electrode(s) 101 may all be mounted to the same first substrate 102 or alternatively different groups of electrodes 101 may be mounted to different substrates.

According to various embodiments an aerosol generator is disclosed comprising a plurality of ring electrodes 101, wherein the ring electrodes 101 are arranged to form a plurality of independently controllable heating zones. The control device 109 may be arranged to independently energize the ring electrodes 101 so that a heating profile is translated along at least a portion of the length of the aerosol generator during a session of use. For example, the control device may be arranged to apply an AC or RF voltage to either individual ring electrodes 101 and/or groups of ring electrodes 101 in a sequential manner or according to a predetermined order. The aerosol provision device may comprise an opening for receiving an aerosol generating article, wherein a first heating zone is arranged proximal the opening and a second heating zone is arranged distal to the opening. The control device 109 may be arranged either: (i) to translate the heating profile from the first heating zone towards the second heating zone during a session of use; and/or (ii) to translate the heating profile from the second heating zone towards the first heating zone during a session of use.

Embodiments are contemplated wherein the aerosol generator comprises 3, 4, 5, 6, 7, 8, 9, 10 or more than 10 independently controllable heating zones and wherein a heating profile may be translated between or along the different heating zones.

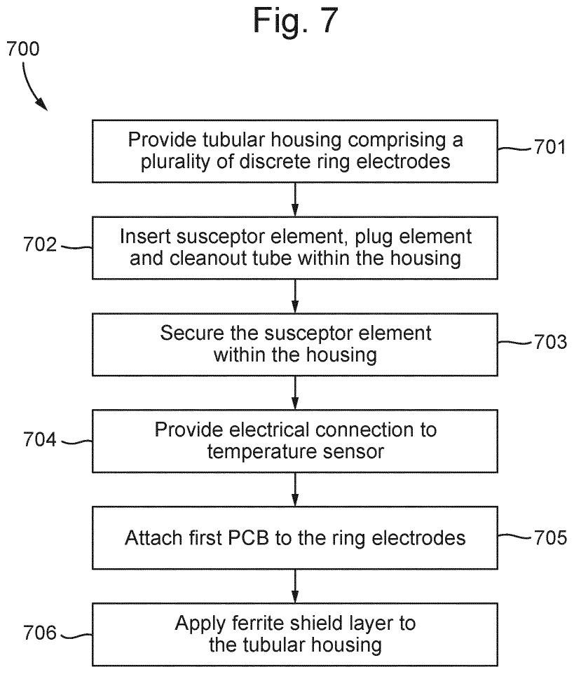

FIG. 7 shows a method 700 of assembling an aerosol generator for an aerosol provision device in accordance with an embodiment of the present disclosure. In accordance with various embodiments, the method 700 illustrates the steps involved in assembling or manufacturing an aerosol generator as disclosed in FIGS. 3-6. In accordance with an embodiment, the method may be used to provide an aerosol provision device as shown in FIG. 1.

The method 700 comprises providing a tubular housing 104 that comprises a plurality of discrete ring electrodes 101 (Step 701). The discrete ring electrodes 101 are embedded within a matrix. The step of providing the tubular housing 104 may comprise injection molding the matrix around the ring electrodes 101. In an embodiment, the step of injection molding comprises: positioning a plurality of ring electrodes 101 within a mold; injecting a matrix into the mold; and causing the matrix to harden around the plurality of ring electrodes 101 to form the tubular housing 104. In various embodiments, the matrix or tubular housing 104 comprises a thermoplastic material, such as polyetheretherketone (“PEEK”).

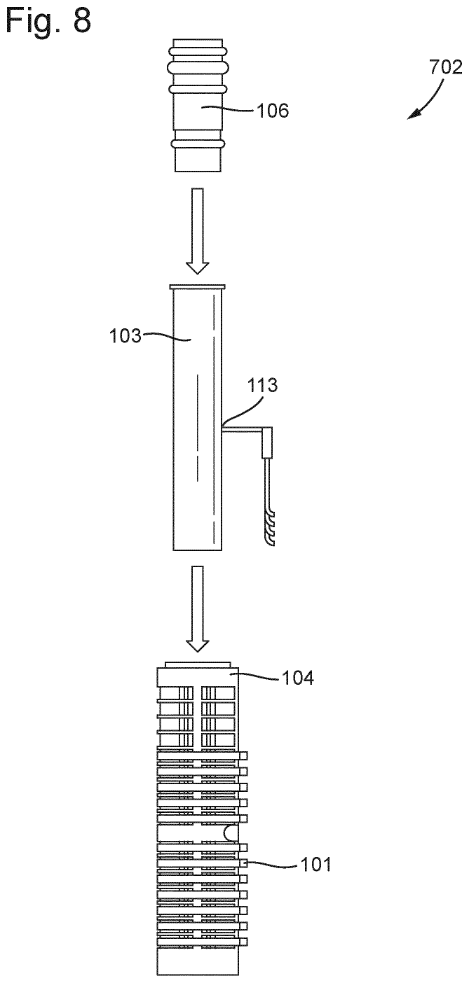

The method 700 further comprises inserting a susceptor element 103 into the tubular housing 104 (Step 702). This step is illustrated in more detail below with reference to FIG. 8. According to various embodiments the susceptor element 103 may be part of sub-assembly which comprises a temperature sensor. According to various embodiments the susceptor element 103 may be attached to either a plug element or a cleanout tube 106.

According to an embodiment the a plug element may be inserted into the tubular housing 104, the susceptor element 103 may then inserted and secured to the plug element and then a cleanout tube 106 may be attached to both the tubular housing 104 and the susceptor element 103.

The method 700 comprises securing the susceptor within the tubular housing 104 (Step 703). Various fittings may be used but beneficially embodiments are contemplated wherein the various components namely the susceptor element 103, the plug element and the cleanout tube 106 can be inserted and secured to each other and the tubular housing 104 without needing the use of glue or screws etc.

The method 700 may further comprise providing an electrical connection from outside of the tubular housing 104 to a temperature sensor, such as a thermocouple, attached to the susceptor 103. The temperature sensor may be provided by securing one or more thermocouple wires 113 to the susceptor element 103, such as using a weld. In an embodiment, the method comprises passing the one or more thermocouple wires 113 through an aperture or cut-out provided in the tubular housing 104 (see FIG. 6). For instance, the one or more thermocouple wires 113 may be attached to the susceptor element 103 prior to the susceptor element 103 being inserted into the tubular housing 104. The one or more thermocouple wires 113 can be passed through the aperture or cut-out after the susceptor element 103 has been inserted into the tubular housing 104. Alternatively, the one or more thermocouple wires 113 may be passed through the aperture or cut-out and secured to the susceptor element 103 after the susceptor element 103 has been inserted into the tubular housing 104.

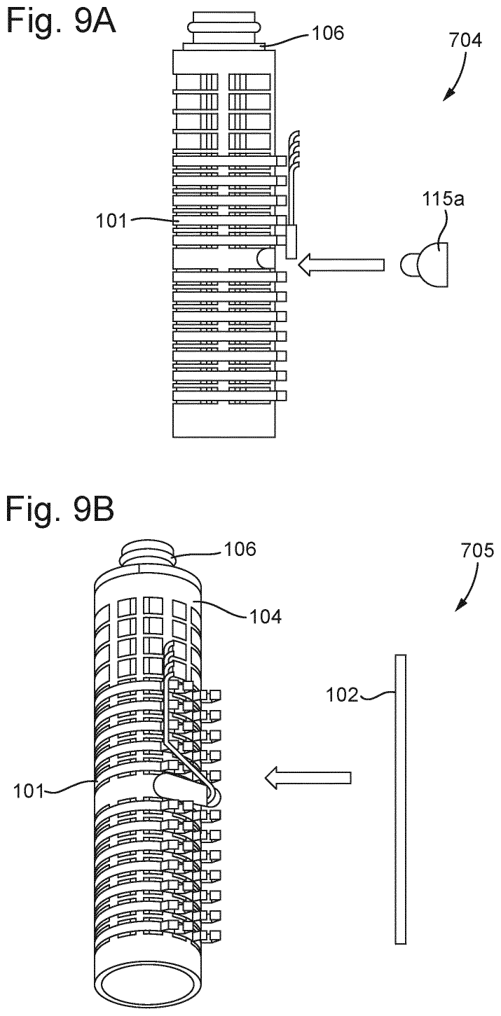

In an embodiment, the method comprises inserting a seal 115a into the aperture or cut-out provided in the tubular housing 104 in order to form a seal around the one or more thermocouple wires 113 with the tubular housing 104. This is shown in both FIGS. 6 and 9A.

The method 700 may further comprise attaching, mounting, securing or soldering the electrical connections to a first substrate 102 (Step 705). The method may comprise arranging for portions of the ring electrodes 101 to extend beyond the tubular housing 104 so as to form electrical connections for the attachment, mounting, securing or soldering of the first substrate 102 to the ring electrodes 101. FIG. 9B shows how the step may be performed. The first substrate 102 may comprise a first PCB.

In an embodiment, Step 705 may be performed after Step 702, 703 and/or 704. However, in other embodiments, Step 705 may be performed as part of Step 701. For instance, the discrete ring electrodes 101 may be attached, mounted, secured or soldered to the first substrate 102 prior to the matrix being injection molded around the ring electrodes 101 to form the tubular housing 104.

In an embodiment, the first substrate 102 comprises one or more electrical connectors or pads and the method further comprises electrically connecting the one or more electrical connectors or pads to one or more electrical connectors or pads provided on a second substrate 150, such as a second PCB 150.

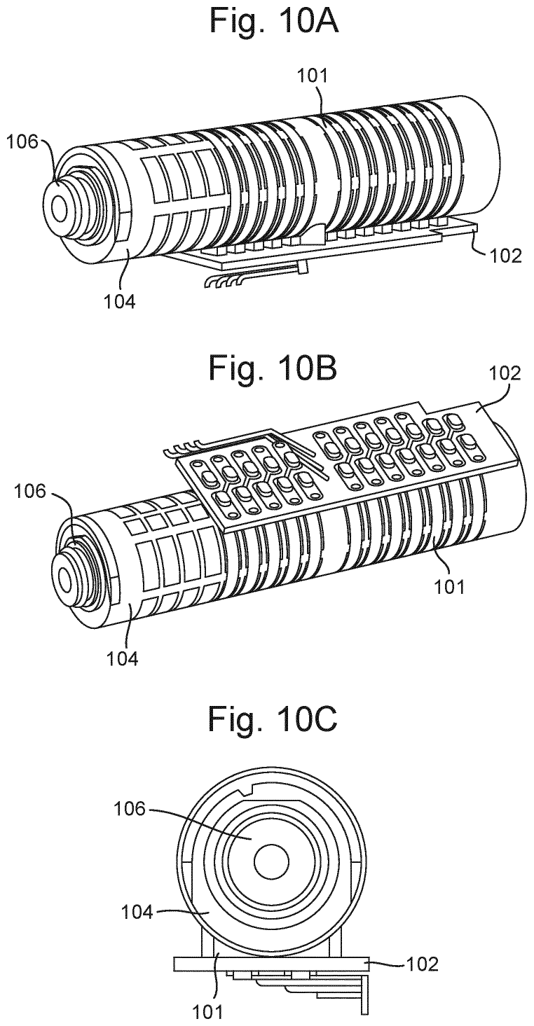

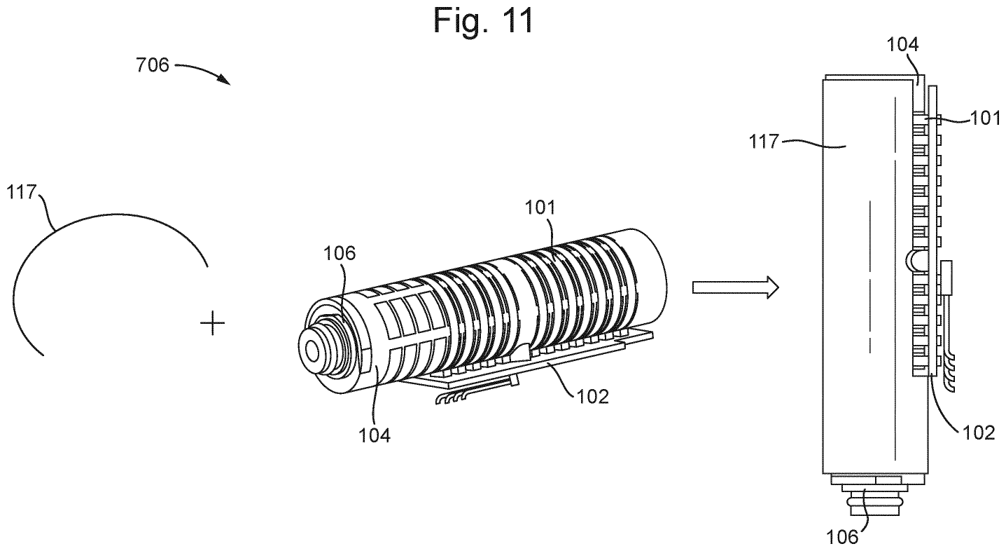

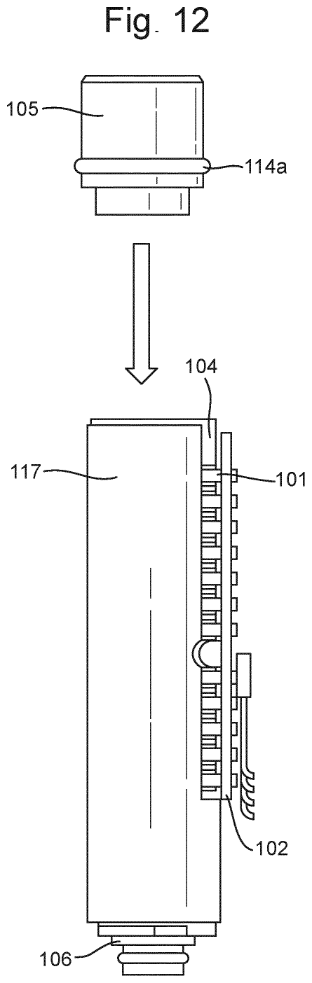

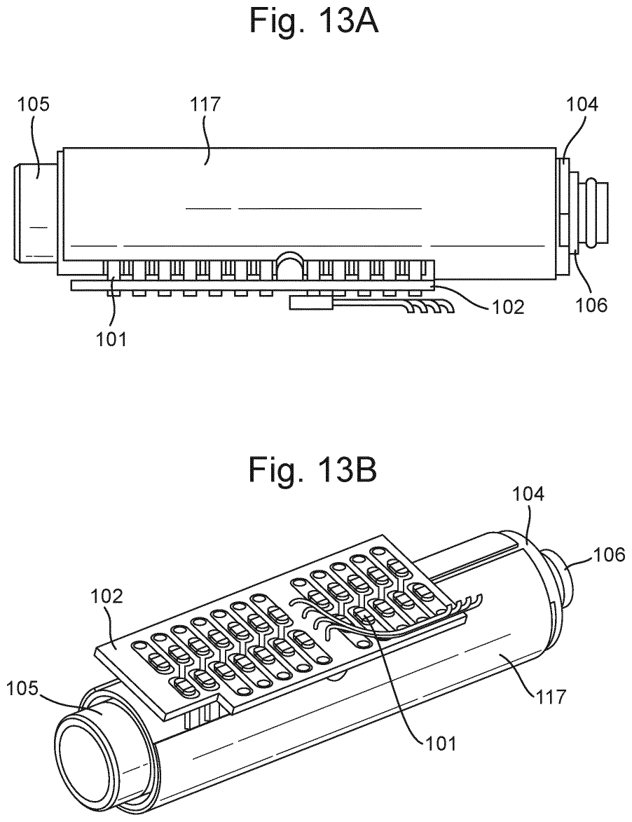

FIGS. 10A-10C show the aerosol generator after the performance of Steps 701-706. The method 700 may comprise applying a ferrite shield layer 117 to the tubular housing 104 (Step 706) as shown in FIG. 11. Applying a ferrite shield layer 117 to the tubular housing may comprise using a self-adhesive to adhere the ferrite shield 117 to the tubular housing. FIG. 12 shows how a plug element 105 which may have a seal 114a may be inserted into the tubular housing 104 after the ferrite shield 117 has been applied to the tubular housing. FIGS. 13A and 13B show the aerosol generator once assembled in accordance with the disclosed method 700.

It will be apparent that according to various embodiments a method of assembling an aerosol generator is disclosed wherein the various components can be easily assembled without requiring the use of fixings, glue or specialist tools. For example, a tubular housing 104 comprising a plurality of ring electrodes 101 embedded within a matrix by an injection molding process may be provided. A susceptor element 103 may be secured to the tubular housing 104 between a plug element 105 and a cleanout tube 106. Both the plug element 105 and the cleanout tube 106 may be attached to the tubular housing 104 and the susceptor element 103 without the use of fixings, glue or specialist tools i.e. the components may snap-fit or make a compression fit with each other.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A method of manufacturing or assembling an aerosol generator for an aerosol provision device, the method comprising:
providing a tubular housing comprising a plurality of discrete ring electrodes embedded within a matrix;
inserting a susceptor element within the tubular housing; and
contacting the susceptor element with a plug element and contacting the susceptor element with a cleanout tube in order to secure the susceptor element within the tubular housing, wherein
(i) the method comprises inserting the plug element and the cleanout tube within the tubular housing, and securing the plug element and the cleanout tube to the tubular housing in order to secure the susceptor element within the tubular housing: or
(ii) the plug element is an integral component of the tubular housing, the susceptor element is inserted within the tubular housing so as to contact the plug element, and the method comprises inserting the cleanout tube within the tubular housing and securing the cleanout tube to the tubular housing in order to secure the susceptor element within the tubular housing: or
(iii) the cleanout tube is an integral component of the tubular housing, the susceptor element is inserted within the tubular housing so as to contact the cleanout tube, and the method comprises inserting the plug element within the tubular housing and securing the plug element to the tubular housing in order to secure the susceptor element within the tubular housing.

2. A method as claimed in claim 1, wherein the plurality of discrete ring electrodes embedded within the matrix comprise an inductor.

3. A method as claimed in claim 1, wherein the susceptor element is secured within the tubular housing by virtue of being positioned or held under compression between the plug element and the cleanout tube.

4. A method as claimed in claim 1, wherein the method comprises:
inserting the plug element into the tubular housing and making a snap fit or interference fit with the tubular housing and/or the susceptor element.

5. A method as claimed in claim 1, wherein the method comprises:
inserting the cleanout tube into the tubular housing and making a snap fit or interference fit with the tubular housing and/or the susceptor element.

6. A method as claimed in claim 1, wherein the step of providing the tubular housing comprises injection molding the matrix around the ring electrodes.

7. (canceled)

8. A method as claimed in claim 1, wherein the matrix or tubular housing comprises a thermoplastic material.

9. (canceled)

10. A method as claimed in claim 1, further comprising arranging for portions of the ring electrodes to extend beyond the tubular housing so as to form electrical connections.

11. A method as claimed in claim 10, further comprising mounting, securing or soldering the electrical connections to a first substrate.

12. (canceled)

13. A method as claimed in claim 11, wherein the first substrate comprises one or more electrical connectors or pads and the method further comprises:
electrically connecting the one or more electrical connectors or pads to one or more electrical connectors or pads provided on a second substrate.

14. (canceled)

15. (canceled)

16. A method as claimed in claim 1, wherein the plurality of ring electrodes are arranged co-axially within the tubular housing.

17. A method as claimed in claim 1, wherein the plurality of ring electrodes are spaced equally axially.

18. (canceled)

19. A method as claimed in claim 1, further comprising securing one or more thermocouple wires to the susceptor element.

20. A method as claimed in claim 19, further comprising passing the one or more thermocouple wires through an aperture or cut-out provided in the tubular housing.

21. A method as claimed in claim 20, further comprising inserting a seal into the aperture or cut-out provided in the tubular housing in order to form a seal around the one or more thermocouple wires with the tubular housing.

22. (canceled)

23. A method as claimed in claim 1, further comprising applying a ferrite shield layer to the tubular housing.

24. A method as claimed in claim 23, wherein the step of applying a ferrite shield layer to the tubular housing comprises using a self-adhesive to adhere the ferrite shield to the tubular housing.

25. (canceled)

26. (canceled)

27. (canceled)

28. An aerosol generator comprising:
a tubular housing comprising a plurality of discrete ring electrodes embedded in a matrix;
a plug element;
a cleanout tube; and
a susceptor element,
wherein the plug element and the cleanout tube contacts the susceptor element in order to secure the susceptor element within the tubular housing, and wherein:
(i) the plug element and the cleanout tube are secured to the tubular housing in order to secure the susceptor element within the tubular housing; or
(ii) the plug element is an integral component of the tubular housing and the cleanout tube is secured to the tubular housing in order to secure the susceptor element within the tubular housing; or
(iii) the cleanout tube is an integral component of the tubular housing and the plug element is secured to the tubular housing in order to secure the susceptor element within the tubular housing.

29. (canceled)

30. (canceled)

31. An aerosol generator as claimed in claim 28, wherein the susceptor element is secured to the tubular housing by virtue of being positioned or held under compression between the plug element and the cleanout tube.

32. (canceled)

33. (canceled)

34. (canceled)

35. A method of manufacturing an aerosol generator comprising:
positioning a plurality of discrete ring electrodes in a mold;
injecting a matrix into the mold; and
allowing the matrix to cool or harden so as to form a tubular housing having a plurality of ring electrodes embedded therewithin.
